(19) United States
(12) Patent Application Publication
(10) Pub. No.: US 2014/0047070 A1
(43) Pub. Date: Feb. 13, 2014

(54) CLOUD COMUTING DEVICE AND METHOD FOR STORING DATA FILES IN CLOUD SERVERS

(71) Applicants: HON HAI PRECISION INDUSTRY CO., LTD., New Taipei (TW); HONG FU JIN PRECISION INDUSTRY (SenZhen) CO., LTD., Shenzhen (CN)

(72) Inventors: CHUNG-I LEE, New Taipei (TW); HAI-HONG LIN, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/942,752

(22) Filed: Jul. 16, 2013

(30) Foreign Application Priority Data
Aug. 10, 2012 (CN) 2012102848764

(51) Int. Cl. H04L 29/08

(52) U.S. Cl. CPC H04L 67/02
USPC 709/219

(57) ABSTRACT

In a method for storing data files to cloud servers using a cloud computing device, the cloud computing device connects to at least one terminal device through a network. The cloud computing device receives one or more data files from the terminal device, and determines a file storing mode of each of the data files. The cloud computing device generates a file information list of the data files according to the file storing modes of the data files, and search the cloud servers in the network according to the file information list. The cloud computing device divides each of the data files into data blocks according to the file information list, uploads each of the data blocks to the cloud servers according to the file storing locations, and stores the file information list in a storage device of the cloud computing device.

### BACKGROUND

1. Technical Field

Embodiments of the present disclosure relate to cloud computing systems and methods, and particularly to a cloud computing device and method for storing data files in one or more cloud servers.

2. Description of Related Art

Cloud computing systems provide computation, software application, data access, and storage services that do not require end-user knowledge of the physical location and configuration of the cloud computing systems. Data files can be stored in cloud storage devices at different remote locations which are accessed from various terminal devices. The data files stored in the different cloud storage devices are accessible by the terminal devices when the terminal devices are connected to a network such as the Internet. However, transmission of data files may hog network resources of the cloud computing system, so as to limit the usefulness of cloud computing services of the cloud computing system. Therefore, there is room for improvement within the cloud computing system.

### BRIEF DESCRIPTION OF THE DRAWINGS

FIG. 1 is a block diagram of one embodiment of a cloud computing device including a cloud file storing system.

FIG. 2 is a flowchart of one embodiment of a method for uploading data files to cloud servers using the cloud computing device of FIG. 1.

FIG. 3 is a flowchart of one embodiment of a method for downloading data files from cloud servers using the cloud computing device of FIG. 1.

FIG. 4 illustrates one exemplary embodiment of a file information list of data files.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

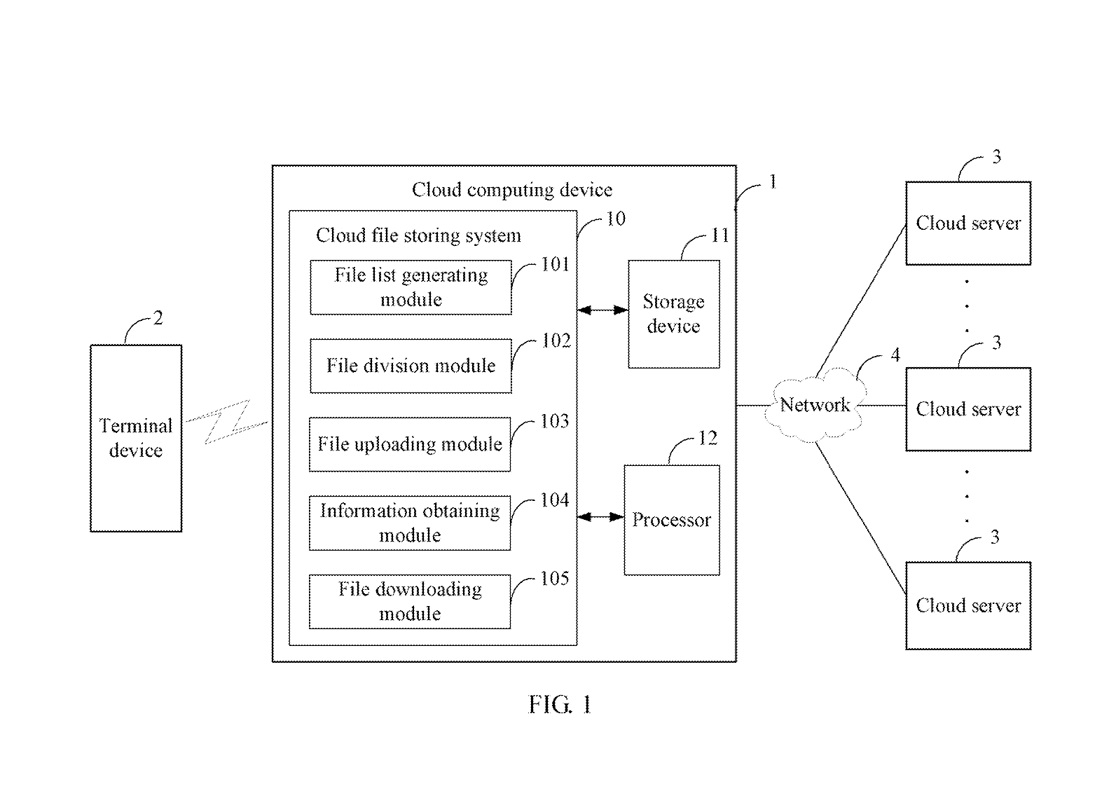

FIG. 1 is a block diagram of one embodiment of a cloud computing device 1 including a cloud file storing system 10. In the embodiment, the cloud file storing system 10 is implemented by the cloud computing device 1, which connects to at least one terminal device 2 through a network 4 such as a WIFI network, and connects to a plurality of cloud servers 3 through the network 4 such as the Internet. In one embodiment, the terminal device 2 may be a personal computer (PC), a notebook, a mobile phone, a PAD device or any other mobile device. Each of the cloud servers 3 provides cloud computing services including computation, application programs, data access, and storage services for the terminal device 2 when the terminal device 2 connects to the cloud server 3.

In one embodiment, each of the cloud servers 3 may be a file server or a data storage system that stores data files, that are uploaded or downloaded from the terminal device 2, and applications that can be shared with the terminal device 2. The terminal device 2 can upload the data files to the cloud servers 3 and download data files from the cloud servers 3 when the terminal device 2 connects to the cloud servers 3 to share cloud computing services. In the embodiment, each of the data files may be a text file, an image file, or a multimedia data file including audio data and video data.

The cloud computing device 1 may include a storage device 11 and at least one processor 12. In one embodiment, the storage device 11 may be an internal storage system, such as a random access memory (RAM) for temporary storage of information, and/or a read only memory (ROM) for permanent storage of information. The storage device 11 may also be an external storage system, such as an external hard disk, a storage card, or a data storage medium. The at least one processor 12 is a central processing unit (CPU) or microprocessor that performs various functions of the cloud computing device 1.

In one embodiment, the cloud file storing system 10 includes a file list generating module 101, a file division module 102, a file uploading module 103, an information obtaining module 104, and a file downloading module 105. The modules 101-105 may comprise computerized instructions in the form of one or more programs that are stored in the storage device 11 and executed by the at least one processor 12. A description of each module is given in the following paragraphs.

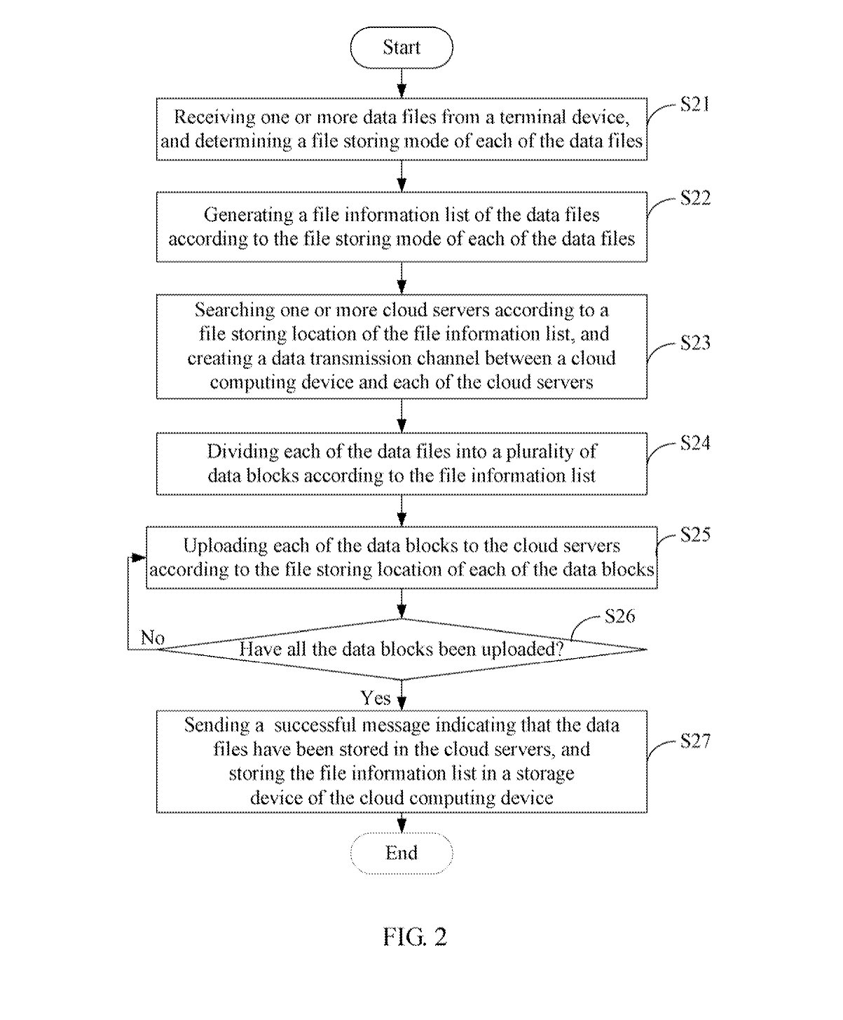

FIG. 2 is a flowchart of one embodiment of a method for uploading data files to the cloud servers 3 using the cloud computing device 1 of FIG. 1. The method is performed by execution of computer-readable programs or instructions by the at least one processor 12 of cloud computing device 1. The method divides a file into a plurality of data blocks when the file is received from the terminal device 2, and dispersedly stores the data blocks into the cloud servers 3. Depending on the embodiment, additional steps may be added, others removed, and the ordering of the steps may be changed.

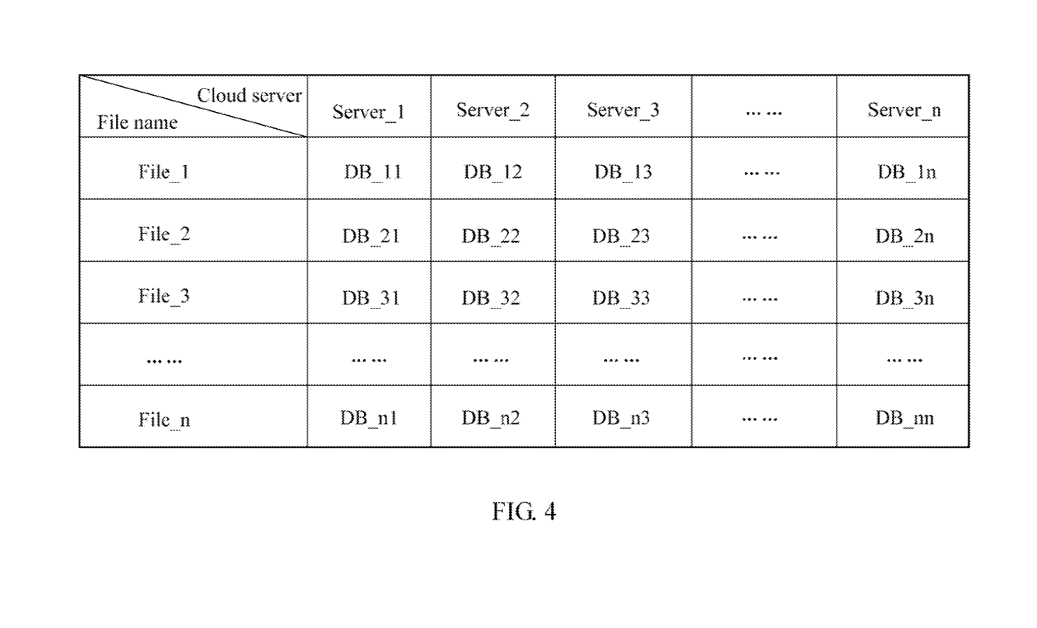

In step S21, the file list generating module 101 receives one or more data files from the terminal device 2, and determines a file storing mode of each of the data files. In one embodiment, the file storing mode of a data file defines how to divide the data file into data blocks, and defines how many data blocks can be stored in each of the cloud servers 3. Referring to FIG. 4, if the data file named File_1 is divided into n numbers of data blocks, such as DB_11, DB_12, DB_13, . . . , and DB_1n, the data blocks can be randomly stored in the cloud servers 3. For example, the data blocks DB_1 and DB_2 are stored in one of the cloud servers 3 named Server_1, and the data block DB_3 is stored in one of the cloud servers 3 named Server_2, and the remainder of data blocks are stored in one of the cloud servers 3 named Server_3.

In step S22, the file list generating module 101 generates a file information list of the data files according to the file storing modes. In the embodiment, the file information list includes a file name of each of the data files, information on data blocks of each of the data files, and a storing location of each of the data blocks that needs to be stored in the cloud servers 3. FIG. 4 illustrates one exemplary embodiment of the file information list of the data files. In the example with respect to FIG. 4, the file name of each of the data files is denoted as File_1, File_2, File_3, . . . , and File_n, each of the data file may be divided into n numbers of data blocks, such as DB_n1, DB_n2, DB_n3, . . . , and DB_nn, and each of the data blocks is stored in the cloud servers 3 named as Server_1, Server_2, Server_3, . . . , and Server_n, respectively.

In step S23, the file division module 102 searches one or more cloud servers 3 according to the file information list, and creates a data transmission channel between the cloud computing device 1 and each of the searched cloud servers 3. For example, if the data file named File_1 needs to be stored in three cloud servers 3, the file division module 102 may search the cloud servers 3 such as Server_1, Server_2 and Server_3 according to the file storing location, and respectively creates a data transmission channel between the cloud computing device 1 and the cloud servers 3 named Server_1, Server_2 and Server_3.

In step S24, the file division module 102 divides each of the data files into a plurality of data blocks according to the file information list. Referring to FIG. 4, the file division module 102 divides the data file named File_1 into n numbers of data blocks such as DB_11, DB_12, DB_13, . . . , and DB_1n, and divides the data file named File_2 into n numbers of data blocks such as DB_21, DB_22, DB_23, . . . , and DB_2n, for example.

In step S25, the file uploading module 103 uploads each of the data blocks to the cloud servers 3 according to the file storing location of each of the data blocks stored in the file information list. Referring to FIG. 4, the file uploading module 103 uploads n numbers of the data blocks DB_11, DB_21, DB_31, . . . , and DB_n1 to the cloud server 3 named Server_1, or uploads n numbers of the data blocks DB_12, DB_22, DB_32, . . . , and DB_n2 to the cloud server 3 named Server_2, for example.

In step S26, the file uploading module 103 determines whether all the data blocks of the data files have been successfully uploaded to the cloud servers 3. If all the data blocks of the data files have been uploaded to the cloud servers 3, step S27 is implemented. Otherwise, if any data block of the data files have not been uploaded to the cloud servers 3, the process goes back to step S25.

In step S27, the file uploading module 103 sends a successful message indicating that the data files have been stored in the cloud servers 3 successfully, and stores the file information list in the storage device 11 of the cloud computing device 1.

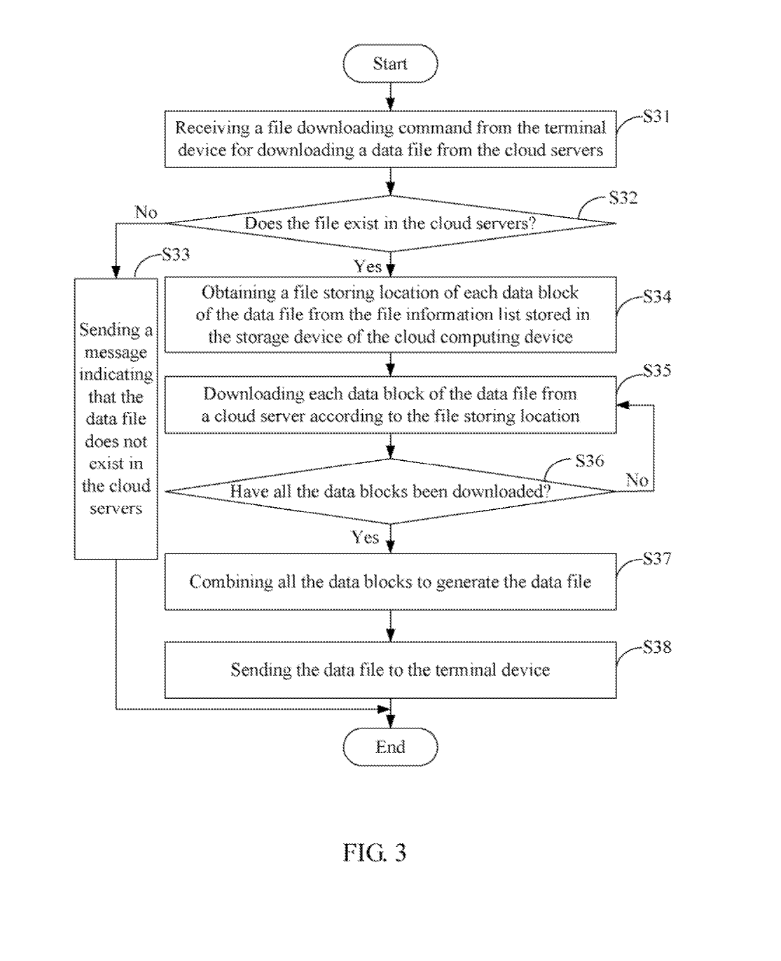

FIG. 3 is a flowchart of one embodiment of a method for downloading data files from the cloud servers 3 using the cloud computing device 1 of FIG. 1. The method is performed by execution of computer-readable programs or instructions by the at least one processor 12 of cloud computing device 1. The method downloads all data blocks of a data file from the relevant cloud servers 3, combines all of the data blocks to generate the data file, and sends the data file to the terminal device 1. Depending on the embodiment, additional steps may be added, others removed, and the ordering of the steps may be changed.

In step S31, the information obtaining module 104 receives a file downloading command from the terminal device 1 for downloading a data file from the cloud servers 3. For example, if a user wants to download a data file named as File_1, the user needs to input the file name File_1 as the file downloading command from the terminal device 1.

In step S32, the information obtaining module 104 checks the file information list to determine whether the data file exists in the cloud servers 3. If the data file exists in the cloud servers 3, step S34 is implemented. Otherwise, if the data file does not exist in the cloud servers 3, step S33 is implemented.

In step S33, the information obtaining module 104 generates a failure message indicating that the data file does not exist in the cloud servers 3, and sends the failure message to the terminal device 1 for informing the user that no data file is found in the cloud servers 3.

In step S34, the information obtaining module 104 obtains a file storing location of each of the data blocks from the file information list stored in storage device 11 of the cloud computing device 1. As shown in FIG. 4, if the data file named File_1 needs to be downloaded from the cloud servers 3, the information obtaining module 104 obtains the data blocks (i.e., DB_11, DB_12, DB_13, . . . , and DB_1n) of the data file named File_1, and downloads each of the data blocks from the cloud servers 3, such as Server_1, Server_2 and Server_3.

In step S35, the file downloading module 105 downloads each data block of the data file from the cloud servers 3 according to the file storing location of each data block stored in the file information list. For example, the data block DB_11 is downloaded from the cloud server 3 named Server_1, the data block DB_12 is downloaded from the cloud server 3 named Server_2, and the data block DB_1n is downloaded from the cloud server 3 named Server_n.

In step S36, the file downloading module 105 determines whether all the data blocks of the data file have been downloaded from the cloud servers 3. If all the data blocks of the data file have been downloaded from the cloud servers 3, step S37 is implemented. Otherwise, if any data block of the data file have not been downloaded from the cloud servers 3, the process goes back to step S35.

In step S37, the file downloading module 105 combines all the downloaded data blocks to generate a complete data file. In the embodiment, the file downloading module 105 generates the complete data file named File_1 by combining all the data blocks (i.e., DB_11, DB_12, DB_13, . . . , and DB_1n) downloaded from the cloud servers 3.

In step S38, the file downloading module 105 sends the complete data file to the terminal device 2 through the network, so that the user can use the data file (e.g., File_1) through the terminal device 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A cloud computing device being connected to at least one terminal device and a plurality of cloud servers through a network, the cloud computing device comprising:
at least one processor; and
a storage device storing one or more program instructions, which when executed by the at least one processor, causes the at least one processor to:
receive one or more data files from the terminal device, and determine a file storing mode of each of the data files;
generate a file information list of the data files according to the file storing mode of each of the data files;
search one or more cloud servers in the network according to the file information list, and create a data transmission channel between the cloud computing device and each of the searched cloud servers;
divide each of the data files into a plurality of data blocks according to the file information list;
upload each of the data blocks to the searched cloud servers through the data transmission channels according to a file storing location of each of the data blocks stored in the file information list; and
store the file information list in the storage device of the cloud computing device.

2. The cloud computing device according to claim 1, wherein the program instructions further cause the at least one processor to:
determine whether all the data blocks of the data files have been uploaded to the cloud servers; and
send a successful message indicating that the data files have been stored in the cloud servers successfully when all the data blocks of the data files have been uploaded to the cloud servers.

3. The cloud computing device according to claim 1, wherein the program instructions further cause the at least one processor to:
receive a file downloading command from the terminal device for downloading a data file from the cloud servers;
obtain a file storing location of each data block of the data file from the file information list stored in the storage device;
download each data block of the data file from the cloud servers according to the file storing location of each data block stored in the file information list; and
combine all the downloaded data blocks to generate the data file, and send the data file to the terminal device.

4. The cloud computing device according to claim 3, wherein the program instructions further cause the at least one processor to:
check the file information list to determine whether the data file exists in the cloud servers;
generate a failure message indicating that the data file does not exist in the cloud servers when the data file does not exist in the cloud servers; and
sends the failure message to the terminal device for informing the user that no data file is found in the cloud servers.

5. The cloud computing device according to claim 1, wherein the file information list comprises a file name of each of the data files, information on the data blocks of each of the data files, and the storing location of each of the data blocks that need to be stored in the cloud servers.

6. The cloud computing device according to claim 5, wherein the data blocks of each of the data files are randomly stored in the cloud servers.

7. The cloud computing device according to claim 1, wherein each of the data files is a text file, an image file, or a multimedia data file including audio data and video data.

8. A method implemented by a cloud computing device, the cloud computing device being connected to at least one terminal device and a plurality of cloud servers through a network, the method comprising:
receiving one or more data files from the terminal device, and determining a file storing mode of each of the data files;
generating a file information list of the data files according to the file storing mode of each of the data files;
searching one or more cloud servers in the network according to the file information list, and creating a data transmission channel between the cloud computing device and each of the searched cloud servers;
dividing each of the data files into a plurality of data blocks according to the file information list;
uploading each of the data blocks to the searched cloud servers through the data transmission channels according to a file storing location of each of the data blocks stored in the file information list; and
storing the file information list in a storage device of the cloud computing device.

9. The method according to claim 8, further comprising:
determining whether all the data blocks of the data files have been uploaded to the cloud servers; and
sending a successful message indicating that the data files have been stored in the cloud servers when all the data blocks of the data files have been uploaded to the cloud servers.

10. The method according to claim 8, further comprising:
receiving a file downloading command from the terminal device for downloading a data file from the cloud servers;
obtaining a file storing location of each data block of the data file from the file information list stored in the storage device;
downloading each data block of the data file from the cloud servers according to the file storing location of each data block stored in the file information list; and
combining all the downloaded data blocks to generate the data file, and sending the data file to the terminal device.

11. The method according to claim 10, further comprising:
checking the file information list to determine whether the data file exists in the cloud servers;
generating a failure message indicating that the data file does not exist in the cloud servers when the data file does not exist in the cloud servers; and
sending the failure message to the terminal device for informing the user that no data file is found in the cloud servers.

12. The method according to claim 8, wherein the file information list comprises a file name of each of the data files, information on the data blocks of each of the data files, and the storing location of each of the data blocks that need to be stored in the cloud servers.

13. The method according to claim 12, wherein the data blocks of each of the data files are randomly stored in the cloud servers.

14. The method according to claim 8, wherein each of the data files is a text file, an image file, or a multimedia data file including audio data and video data.

15. A non-transitory storage medium having stored thereon instructions that, when executed by at least one processor of a cloud computing device, cause the cloud computing device to perform a method, the cloud computing device being connected to at least one terminal device and a plurality of cloud servers through a network, the method comprising:
receiving one or more data files from the terminal device, and determining a file storing mode of each of the data files;
generating a file information list of the data files according to the file storing mode of each of the data files;
searching one or more cloud servers in the network according to the file information list, and creating a data transmission channel between the cloud computing device and each of the searched cloud servers;
dividing each of the data files into a plurality of data blocks according to the file information list;
uploading each of the data blocks to the searched cloud servers through the data transmission channels according to a file storing location of each of the data blocks stored in the file information list; and
storing the file information list in a storage device of the cloud computing device.

16. The storage medium according to claim 15, wherein the method further comprises:
determining whether all the data blocks of the data files have been uploaded to the cloud servers; and
sending a successful message indicating that the data files have been stored in the cloud servers when all the data blocks of the data files have been uploaded to the cloud servers.

17. The storage medium according to claim 15, wherein the method further comprises:
receiving a file downloading command from the terminal device for downloading a data file from the cloud servers;
obtaining a file storing location of each data block of the data file from the file information list stored in the storage device;
downloading each data block of the data file from the cloud servers according to the file storing location of each data block stored in the file information list; and
combining all the downloaded data blocks to generate the data file, and sending the data file to the terminal device.

18. The storage medium according to claim 17, wherein the method further comprises:
checking the file information list to determine whether the data file exists in the cloud servers;
generating a failure message indicating that the data file does not exist in the cloud servers when the data file does not exist in the cloud servers; and
sending the failure message to the terminal device for informing the user that no data file is found in the cloud servers.

19. The storage medium according to claim 15, wherein the file information list comprises a file name of each of the data files, information on the data blocks of each of the data files, and the storing location of each of the data blocks that need to be stored in the cloud servers.

20. The storage medium according to claim 15, wherein the data blocks of each of the data files are randomly stored in the cloud servers.
